(19) United States
(12) Patent Application Publication
(10) Pub. No.: US 2004/0197244 A1
(43) Pub. Date: Oct. 7, 2004

(54) Corona discharge plate electrode ozone generator

(76) Inventor: Alan Kirby, Lethbridge (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/407,824

(22) Filed: Apr. 3, 2003

(51) Int. Cl. B01J 19/08

(52) U.S. Cl. 422/186.07

(57) ABSTRACT

The invention relates to a plate type ozone generator having flat plate electrodes separated by ceramic dielectric plates. The generator comprises a plurality of perforated metal electrode plates separated by ceramic dielectrics stacked on top of one another. Ozone is produced when an oxygen containing feed gas is passed through a corona discharge between each electrode and dielectric in the stack. The feed gas acts to cool the generator. The ozone generator is housed in a fiberglass case with all the necessary power and monitoring circuitry also located in said case. The ozone generator produces a relatively low amount of heat and requires only one small fan and two small aluminum heat sinks for cooling.

### FIELD OF THE INVENTION

The present invention relates generally to ozone generators, and particularly, to a plate electrode-type ozone generator that produces ozone by means of corona discharge between electrodes.

### BACKGROUND OF THE INVENTION

Ozone, O₃, is an allotropic, triatomic form of oxygen and is a colourless gas that is soluble in cold water and in alkalis. It is a powerful oxidizing agent that kills bacteria and decomposes many organic substances that are otherwise difficult to remove from water. Ozone treatment of water has long been used as an effective method for preparing fresh water for human consumption.

Ozone occurs when an electrical charge, such as lightning or corona discharge, molecularly disassociates a stable O₂ molecule to produce two unstable oxygen atoms. Seeking stability, these atoms attach to other O₂ molecules, thereby creating ozone.

There are two common approaches to manufacturing ozone. The first is known as corona discharge (“CD”) ozone generation and involves passing dry air or an oxygen-containing gas through a high energy electrical field. The second approach is known as ultraviolet ozone generation and involves passing air or oxygen-containing gas through a source of ultraviolet radiation.

The technologies involved in corona discharge (“CD”) ozone generation are varied, but all operate fundamentally by passing dried, oxygen-containing gas through an electrical field. At the heart of a corona discharge ozone generator is a dielectric material. An electrical charge is diffused over the surface of the dielectric material, creating an electrical field, or “corona”. The electrical current causes a split in the O₂ molecule. In known CD-type ozone generators, around 85% to 95% of the electrical energy supplied to a corona discharge ozone generator produces heat. Therefore, heat removal is a critical issue in such generators. A substantial amount of energy is expended in providing adequate cooling for CD-type ozone generators, and as a result, such generators tend to be costly to operate, i.e. have a low output of ozone per input of electricity. Also, such generators tend to have a short operating life due to early material decomposition caused by the ozone formation.

U.S. Pat. No. 5,525,310 (Decker et al.) discloses a corona discharge ozone generating device having a plurality of stainless steel wire mesh grid electrodes interposed with ceramic dielectric plates. Decker et al. disclose that such mesh grid electrodes have a waffle-like, cross-hatch pattern of approximately 22 gauge stainless steel wire providing screen voids of approximately 1 mm length on each side of the void, and that it is within these voids and adjacent to surface of the dielectric plates that corona formation occurs thereby providing the reaction side to O₂ breakdown and O₃ formation. Decker et al. state that their ozone generator provides a reduced voltage corona discharge that avoids decomposition upon ozone generation, and permits a high ratio of ozone output per ampere of electricity introduced.

However, it has been found that use of such mesh grid electrodes in an ozone generator creates unsatisfactory corona formation; it appears that the weave of the mesh forms an uneven electrode surface of peaks and nadirs, which results in localized corona formation around the peaks.

It is therefore desirable to provide an improved corona discharge ozone generator, and especially one that provides improved ozone generation output and efficiency, and reduced heat generation.

### SUMMARY OF THE INVENTION

The present invention provides a means of producing ozone by corona discharge that is less subject to heat problems commonly found in conventional CD ozone generators. According to one aspect of the invention, there is provided a corona discharge ozone generator comprising at least two flat metallic electrode plates arranged in substantially parallel spaced-apart configuration; a dielectric member interposed between each pair of electrode plates; and a feed gas flow path extending through the space between each pair of electrode plates and past the interposed dielectric member. Each electrode plate is electrically connectable to an electric power source, and at least one of the electrode plates is perforated. The generator is operable to create a corona discharge that generates ozone from an oxygen-containing feed gas flowing through each flow path. The flow paths may extend over substantially all of the confronting surfaces of each pair of electrode plates.

Each electrode plate may be made of stainless steel. Each dielectric plate may be made of fired alumina.

All the electrode plates in the generator may be perforated. The perforations may be in the form of holes arranged in a staggered grid pattern in the electrode plates. The holes may be substantially circular. Further, the holes may be substantially evenly distributed across the electrode plates. 23%+/−5% of the electrode plate surface area may be perforated by these substantially circular holes.

The electrode plates and dielectric plates may be vertically stacked in such a manner that adjacent flow paths are fluidly interconnected, thereby forming a continuous flow path from one end of the stack to the other. In particular, the dielectric plates may be horizontally positioned in the stack in such a manner that a continuous serpentine flow path is formed extending from one end of the stack to the other. More particularly, the dielectric plates may be horizontally positioned in the stack to direct the flow of feed gas past a single electrode plate with each horizontal pass in the serpentine flow path. Alternatively, the dielectric plates may instead be horizontally positioned to direct the flow of feed gas past a pair of electrode plates with each horizontal pass in the serpentine flow path.

### BRIEF DESCRIPTION OF THE DRAWINGS

FIG. 1 is a schematic sectioned side view of a single pass ozone generator according to a first embodiment of the invention.

FIG. 2 is a schematic illustration of a feed gas flow path through the generator shown in FIG. 1.

FIG. 3 is a schematic sectioned side view of a dual pass ozone generator according to a second embodiment of the invention.

FIG. 4 is a schematic illustration of a feed gas flow path through the generator shown in FIG. 2.

FIG. 5 is an isometric view of an eight plate single pass generator.

FIG. 6 is a plan view of a ceramic plate of the ozone generators shown in FIGS. 1-5.

FIG. 7 is a plan view of a perforated metal electrode plate of the ozone generators shown in FIGS. 1-5.

FIG. 8 is a schematic illustration of a circuit board for controlling the operation of the ozone generators of FIGS. 1-5.

FIG. 9 is a wiring diagram of the components of the ozone generators of FIGS. 1-5.

FIG. 10 is a schematic plan view of a perforated stainless plate electrode of a ozone generator according to a third embodiment of the invention.

FIG. 11 is a schematic plan view of the plate electrode shown in FIG. 10 embedded in a ABS Moulded stacking divider frame.

FIG. 12 is a schematic sectioned side view of two plate electrodes and their divider frames interposed between three ceramic dielectric plates.

FIG. 13 is a schematic top view of a ported housing cover of the third embodiment of the ozone generator.

FIG. 14 is a schematic side view of the ported housing cover shown in FIG. 13.

FIG. 15 is a top view of a housing for the third embodiment of the ozone generator, for receiving electrode and dielectric plates.

FIG. 16 is a schematic plan view of the electrode and divider shown in FIG. 11 with arrows indicating the flow of air therethrough.

### DETAILED DESCRIPTION OF EMBODIMENTS OF THE INVENTION

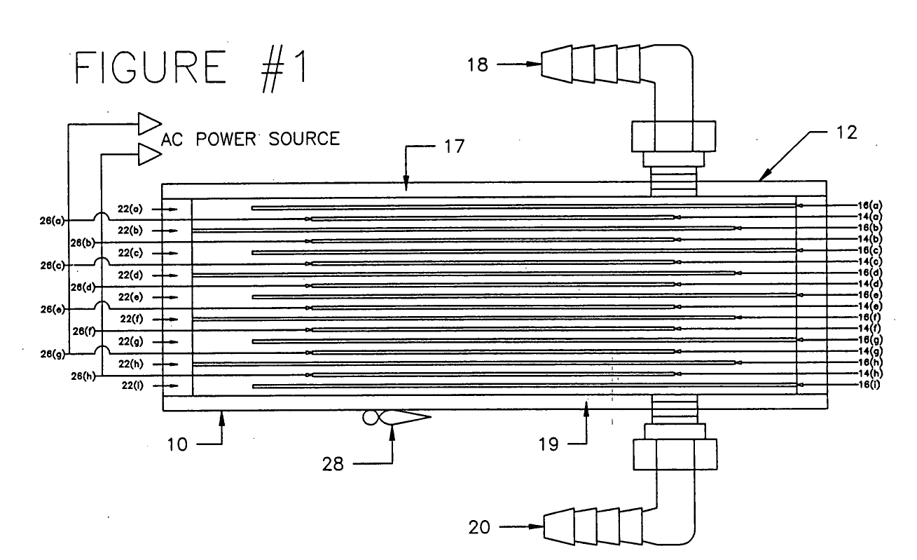

According to one embodiment of the invention, and referring to FIGS. 1, 2, and 5, an ozone generator 10 produces ozone by corona discharge. The ozone produced is particularly useful in treating water, and for example, may be used in a water treatment system (not shown) that treats a source water stream with ozone. While the ozone generator 10 may be used for other applications, this description relates to the use of the ozone generator 10 in a water treatment system having a venturi-type, differential pressure injector (not shown) for injecting ozone into the water stream. A suitable such injector is a Mazzei® Injector manufactured by Mazzei Injector Corporation. The injector has a water conduit with an inlet and outlet, and a suction port intersecting the water conduit; pressurized water flow through the water conduit creates a suction force through the suction port, causing a fluid such as ozone to be sucked through the suction port and injected into the water stream.

The generator 10 has an ozone generation stack 12 that contains a plurality of flat electrodes plates 14(a)-(h) separated by a plurality of flat dielectric plates16(a)-(i). The stack 12 comprises a top cover 17 having an inlet that receives an inlet conduit 18, a bottom cover 19 having an outlet that receives an outlet conduit 20, and a plurality of divider frames 22(a)-(i) stacked between the top and bottom covers 17, 19. The inlet conduit 18 is fluidly coupled to a dry air source (not shown). The outlet conduit 20 is fluidly coupled to the suction port of the ozone injector.

Each divider frame 22(a)-(i) is a rectangular frame injection-molded from an ABS material that is ozone-resistant and fire-resistant. Ozone-resistant fire-rated ABS is used as the divider material because it can be easily sealed. One or more grooves (not shown) are formed around the inside edges of each divider frame 22(a)-(i) for receiving the edges of one or both of an electrode plate 14(a)-(h) and a dielectric plate 16(a)-(i). Each of the ABS divider frames 22(a)-(i) are stacked and sealed together using a solvent that contains methylene chloride, trichloroethylene and methacrylate monomer.

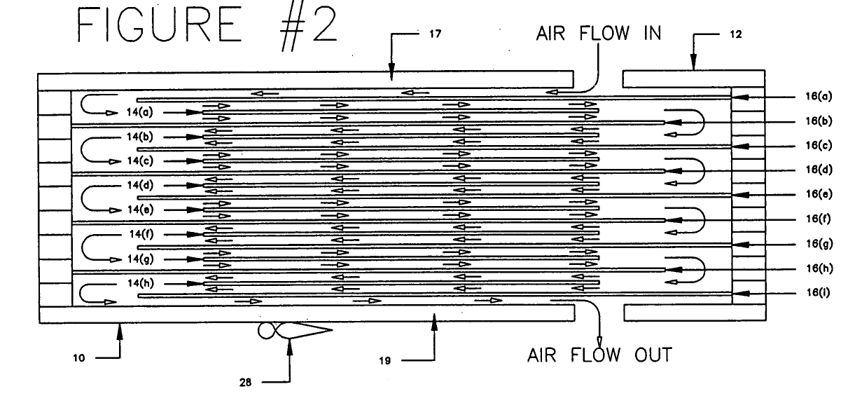

Referring particularly to FIG. 2, the number of electrode plates 14 in the stack 12 may be selected depending on the ozone output desired, and in this embodiment, eight electrode plates 14 (a)-(h) are arranged in parallel longitudinal arrangement and are interposed between nine dielectric plates 16 (a)-(i) also arranged in a parallel longitudinal arrangement.

The electrode plates 14(a)-(h) and dielectric plates 16(a)-(i) extend the width of the stack 12, and are mounted to the side walls of their respective dividers 22(a)-(i). The electrode plates 14(a)-(h) are mounted in the stack 12 so that a space is provided between each longitudinal edge of each electrode plate 14(a)-(h) and the end walls of their respective divider frames 22(a)-(i). The dielectric plates 16(a),(c), (e), (g), (i) are mounted inside the stack 12 so that their right longitudinal edge abuts against the right end wall of their respective divider frames 22(a),(c),(g)(i), and the dielectric plates 16(b),(d),(f),(h) are mounted so that their left longitudinal edge abuts against the left end wall of their respective dividers frames 22(b),(d),(f),(h). This arrangement of electrode plates 14(a)-(h) and dielectric plates 16(a)-(i) define a serial single-pass serpentine air flow path inside the stack 12, represented by the arrows in FIG. 2. That is, feed gas (dried air or another oxygen-containing gas) enters the generator stack 12 through the inlet conduit 18. Once inside, the feed gas is channeled to flow past the first plate electrode 14(a) due to the position of the ceramic dielectric plates 16(a) and (b). The dielectric member 16(b) also serves in conjunction with dielectric 16(c) to direct air flow past the second plate electrode 14(b). As such, the flow of gas is reversed from its original direction, will pass the second electrode 14(b), and is again reversed to pass the next plate electrode 14(c) in the series. Once the gas has passed all of the plate electrodes 14(a)-(h), the ozone produced will exit the generator stack 12 at outlet conduit 20.

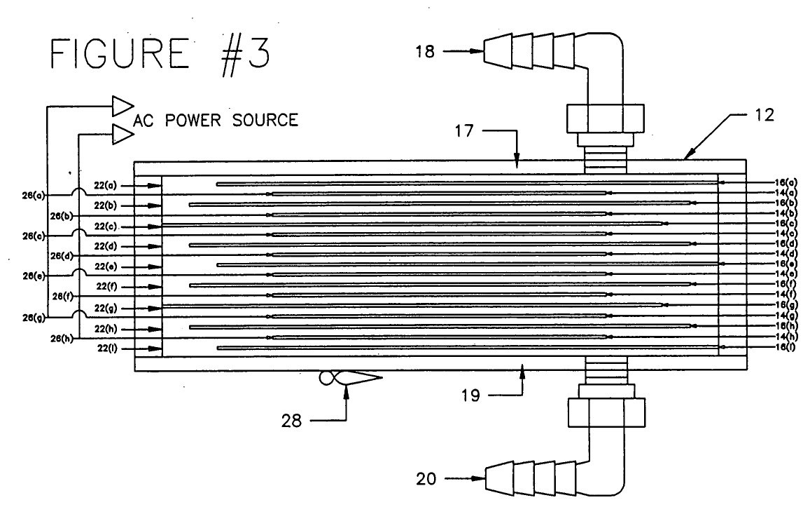

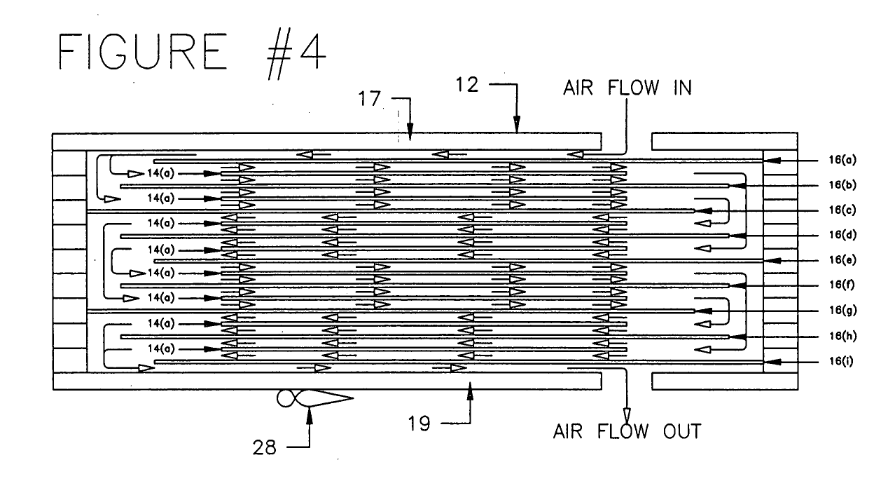

According to a second embodiment of the invention, and referring to FIGS. 3 and 4, the dielectric plates 16(a)-(i) may be mounted inside the stack 12 to create a dual-pass serpentine feed gas flow path, illustrated by the arrows in FIG. 4. This feed gas flow path allows feed gas to flow past pairs of plates at one time, thereby providing a larger feed gas flow capability than a single pass feed gas flow path; this flow path is shown by arrows in FIG. 4. Here, feed gas enters the generator stack 12 through inlet conduit 18. Once inside, the feed gas is channelled to flow past the first set of plate electrodes 14(a) and 14(b) due to the position of the ceramic dielectric plates 16(a),(b) and (c). The dielectric member 16(b) is positioned to allow feed gas to flow past both electrodes 14(a) and (b). Dielectric member 16(d) also serves in conjunction with dielectric 16(e) to direct feed gas to flow past the plate electrodes 14(c) and (d). As such, the flow of gas is reversed from its original direction, will pass electrodes 14(c) and (d), and is again reversed to pass the next plate electrode pair in the series, 14(e) and (f) followed by 14(f) and (h). Once the gas has passed all of the plate electrodes 14(a)-(h) the ozone produced will exit the generator stack 12 at outlet 20.

It is to be understood that uses of the terms “top”, “boftom”, “left”, and “right” are used merely for convenient reference, and are not to be construed to limit the orientation of the generator 10.

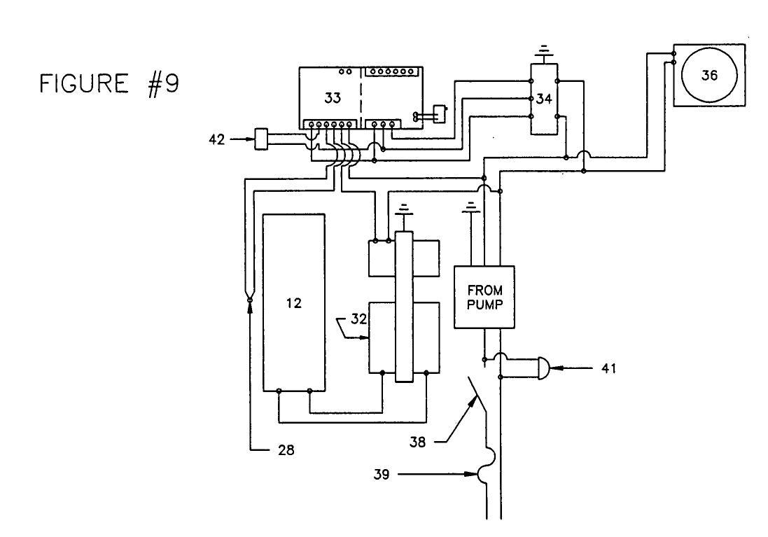

Referring particularly to FIGS. 1, 3 and 5, and for both embodiments, a stainless electrically-conductive wire 26(a)-(h) is spot-welded to each plate electrode 14(a)-(h) and extends through the divider frame 22(a)-(i) of each respective electrode 14(a)-(h) to the outside of the stack 12. All of the wires protrude from the same end of the stack 12, but each alternating electrode wire emerges on the opposite side of the same end of the stack 12. The wires on opposite sides of said end are connected to opposite poles of a high voltage alternating current (AC) source 32 (shown schematically in FIG. 9). which corresponds to each adjacent electrode plate 14 having connection to opposite poles of the high voltage AC source. Specifically, wires 26 (a), (c), (e) and (g) are electrically connected to one pole of the alternating current source 32, while wires 26 (b), (d), (f) and (h) are electrically connected to the other pole. A thermistor 28 is mounted against the outside surface of the bottom cover 19 to monitor the temperature inside the generator 10.

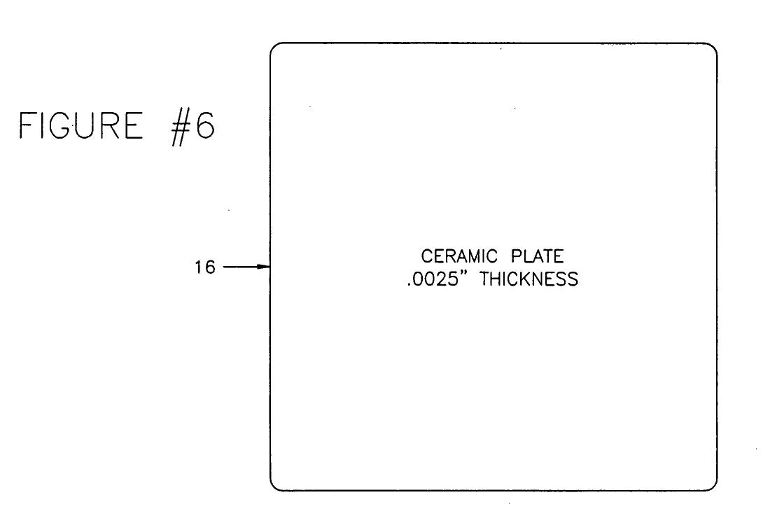

Referring to FIG. 6, the dielectric plates 16(a)-(i) are square ceramic plates 4-½″ (11.4 cm) by 4-1/2″ (11.4 cm) in area with a thickness of 0.025″ (0.064 cm). However, it is within the scope of the invention for the dielectric plates 16(a)-(i) to have other dimensions. The ceramic dielectric plates 16 are made of fired alumina with the following composition:

Al₂O₃ (Aluminum Oxide)>90.0%

SiO₂ (Total Silicon Dioxide)<5.0%

SiO₂ (Free Silicon Dioxide)<1.0%

TiO₂ (Titanium Dioxide)<2.0%

Fe₂O₃ (Iron III Oxide)<2.0%

MnO₂ (Manganese Dioxide)<3.0%

MgO (Magnesium Oxide)<1.0%

CaO (Calcium Oxide)<1.0%

This composition has been found to provide the dielectric plates 16(a)-(i) with good moisture resistance, and relatively low production cost.

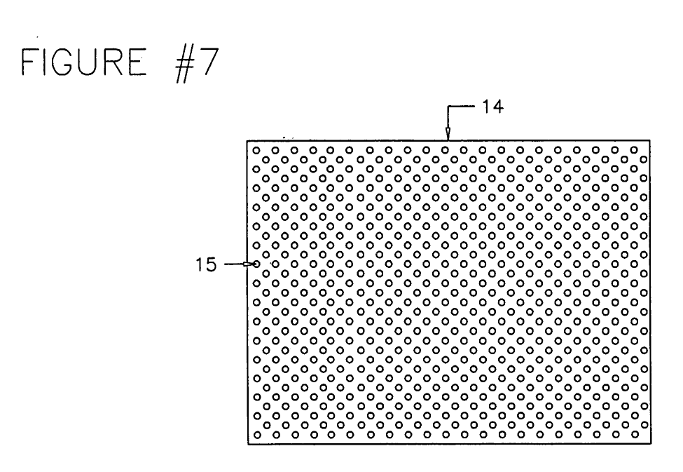

Referring to FIG. 7, the electrode plates 14(a)-(h) are each a perforated stainless steel plate that may be of various thickness and hole size. The electrode plates 14(a)-(h) are typically about 4″ (10.16 cm) by 3″ (7.62 cm) in size and about 0.030″ (0.0762 cm) thick, with approximately 837 holes per plate, each hole 15 being about 0.065″ (0.1651 cm) in diameter, This amounts to about 23% of the surface area of each electrode plate 14 being perforated; preferably, the total perforated surface area is within +/−5% of this value. (Note: FIG. 7 is a schematic only and is not representative of the preferred number of holes 15 in the electrode plate 14).

Other plate and hole shapes and sizes may also be used within the scope of the invention. For example, oval holes and elongated slits may be used, although it has been found that circular holes 15 provide particularly good corona formation and are relatively inexpensive to manufacture. These perforated stainless steel plates 14(a)-(h) have been found to provide better teed gas flow, less heat production, and better corona discharge characteristics than solid plates of comparable dimensions and other properties. Corona discharge tends to occur on areas of the plate where there are angles, such as the edges of the plates. Therefore unlike solid plates, which only produce a corona around the edges, the perforated plates 14 produce a corona that is more evenly spread across the entire plate surface.

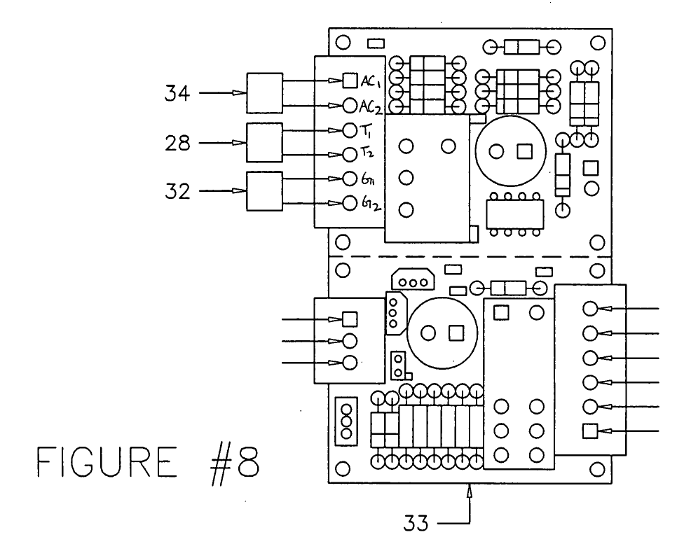

The space between plate electrodes 14(a)-(h) can vary depending on the exact thickness of plate electrodes used. The space between plate electrodes 14(a)-(h) and ceramic dielectric plates 16(a)-(i) will also vary for the same reason. The normal plate gap, that is the distance between plate electrodes, is 0.075″ (0.1905 cm) The stack 12 is a sealed unit with only the inlet conduit 18 and outlet conduit 20 for airflow and stainless wires 22(a)-(i) that protrude out of the stack 12. Referring to FIGS. 8 and 9, the stack 12 is housed inside an appropriately sized fibreglass industrial control panel enclosure (not shown) that also contains monitoring and controlling components. These components include the thermistor 28, the AC coil 32; a circuit board 33, a transformer 34, a fan 36, a shut off valve (not shown), a main power switch 38, a fuse 39, a power indicator light 41, and a vacuum switch 42.

The thermistor 28 is mounted on the part of the stack 12 that is typically the warmest during during ozone generation. The thermistor 28 is electrically coupled to the circuit board at contacts T1 and T2.

The coils 32 are electrically connected at its poles to the wires 26(1)-(h) and produces levels of AC voltages required by the stack 12 to produce ozone. The coils 32 are Acton model FG3424-02 coils; however, one skilled in the art may substitute another suitable and commercially available AC coil in place of the Acton coils. The generator 10 can be powered by a range of high voltages and frequencies of an alternating current source. Higher voltages are used with larger generators, where greater ozone production is desired, and lower voltages are used for smaller generators where lower outputs are adequate. Normally a voltage between 3500V and 4200V is used for 8 to 10 plate generators. The frequency of the alternating current source is increased only when a greater generator output is required and the majority of the smaller units will run on 60 Hz. The frequency of the alternating current source may be varied to change the production of ozone within the ozone generator 10.

The circuit board 33 includes a controller (not shown), a switch (not shown), and a number of contacts for connecting to sensors and other devices of the generator 10, including contacts AC₁, AC₂, T₁, T₂, G₁, and G₂ as shown in FIG. 8. The controller of the circuit board 33 monitors the operating temperature of the stack 12 by reading the thermistor 28; when the temperature measured by the thermistor 28 is higher than a programmed cut-off temperature, the circuit board 33 will turn the generator 10 off by opening the on-board switch. The circuit board 33 will restore power to the generator 10 when the generator temperature measured by the thermistor 28 drops sufficiently below the cut-off temperature.

The transformer 34 is a Hammond model 166G20 transformer and electrically couples the circuit board 33 to the other power components in the generator 10. It is electrically connected to the circuit board 33 at contacts AC1 and AC2. However, one skilled in the art may substitute another suitable and commercially available transformer in place of the Hammond transformer.

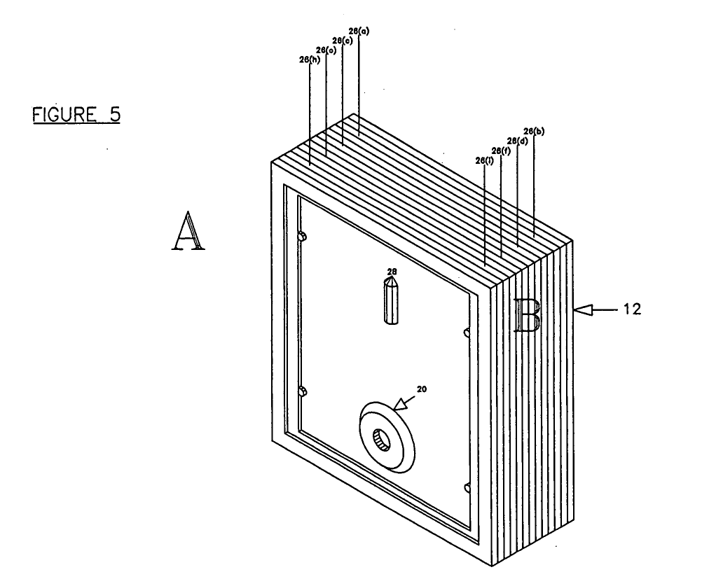

The fan 36 is an Orion-type AC fan model 0A825-AP-11-1-TD that uses 110 volts 60 Hz. The fan 36 is mounted near the coils 32 and is operated to cool the coils 32 and other components inside the generator enclosure. Optionally, and especially for operation in warmer climates, the generator 10 may include a pair of 2.047″ (5.2 cm)×4.528″ (11.5 cm) aluminium heat sinks affixed to the opposing edges of the stack 12 (indicated as A and B in FIG. 5).

The vacuum switch 42 is a neoprene diaphragm located in the supply air steam upstream of the inlet conduit 18. The vacuum switch 42 is coupled to the circuit board 33 via the transformer 34. When feed gas flows through the supply air stream and into the generator 10, the vacuum switch 42 will close. When the circuit board 33 reads an open state of the vacuum switch 42, e.g. in the event the water treatment system is shut down and the air supply stream is stopped from lack of suction from the ozone injector, it will shut down the generator 10 by opening the on-board switch.

A shut-off valve (not shown) is located in the supply water stream of the water treatment system and is electrically coupled to the circuit board 33. The shut-off valve is coupled to the circuit board 33 via the transformer 34. During normal operation, the shut-off valve is in an open position. However, the circuit board 33 sends a control signal to shut the valve, and thus the water stream, in the event the generator 10 is shut down; this ensures public safety by eliminating the possibility that owner of the water treatment system would consume untreated water, e.g. in the event of a generator failure.

In operation, pressurized water flow through the ozone injector creates a suction force through the suction port, which in turn creates a suction force through the generator 10. This suction force draws air or another suitable oxygen-bearing feed gas from the feed gas source, through the inlet conduit 18, through the serpentine feed gas flow path inside the stack 12 and past the electrodes 14(a)-(h) and dielectric plates 16(a)-(i), and out of the stack 12 through the outlet conduit 20. Electricity supplied by the AC coils 32 creates a corona discharge at the electrode plate 14(a)-(h), thereby producing ozone at each consecutive electrode 14(a)-(h). The generated ozone is carried through the stack 12 by the feed gas and the concentration of ozone in the feed gas rises incrementally at each consecutive electrode. The ozone and unreacted feed gas is exhausted from the generator 10 at outlet conduit 20 and into the ozone injector for use by the water treatment system.

The perforations 15 in the steel electrode plate 14 have been found to create localized areas of turbulence in the feed gas flow path. It is believed that this turbulence improves the absorption of ozone by the feed gas, by disrupting the laminar flow of the feed gas through the feed gas flow path. The feed gas, if air, has an ozone absorptivity of about 3-4%, i.e. about 3-4% of the O₂ in the air can be converted into ozone. When in laminar flow, a layer of the air nearest the electrode plate 14 becomes saturated with ozone, forming a barrier against the O₂ in the rest of the air stream to form ozone. The perforated electrode plates 14 thus serve to disrupt the laminar flow of the feed gas thereby enabling more of the O₂ in the feed gas to be converted into ozone,

The perforations 15 have also been found to increase the amount of corona discharge per unit area of electrode over conventional solid electrode plates, with a corresponding decrease in heat generated. This has the dual benefit of improving the operating efficiency of the generator 10 as well as reducing the heat generated. As a result of the reduced heat generation, it has been found that the rate of feed gas flowing through the generator 10 is sufficient to keep the generator 10 sufficiently cool during operation—around 6-8 L/min. In particular, the flow of feed gas is sufficient to keep generator at an optimal temperature for ozone production, and safely below a temperature that would result in degradation of the produced ozone, around a maximum of 40° C. Where extra air flow is required, the second embodiment of the generator 10 as shown in FIGS. 2 and 3 may be used to allow the feed gas to pass two electrode plates 14 at once rather than each plate 14 consecutively.

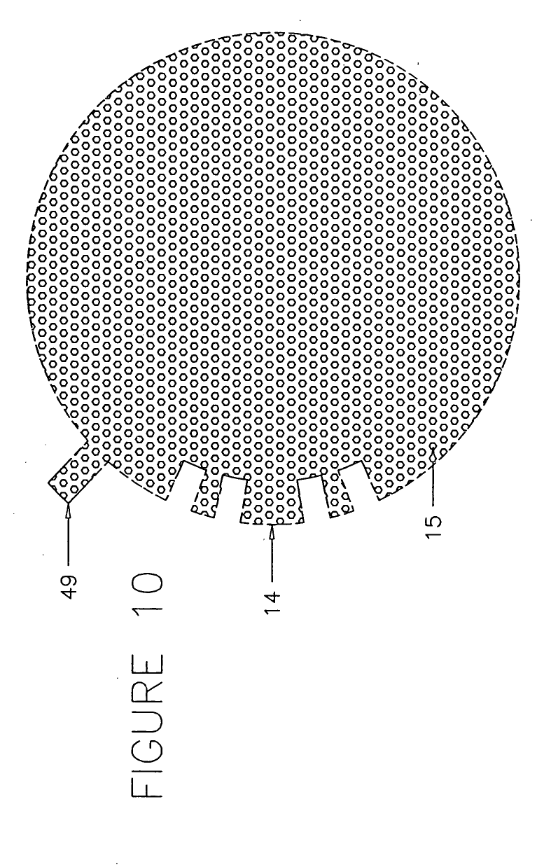

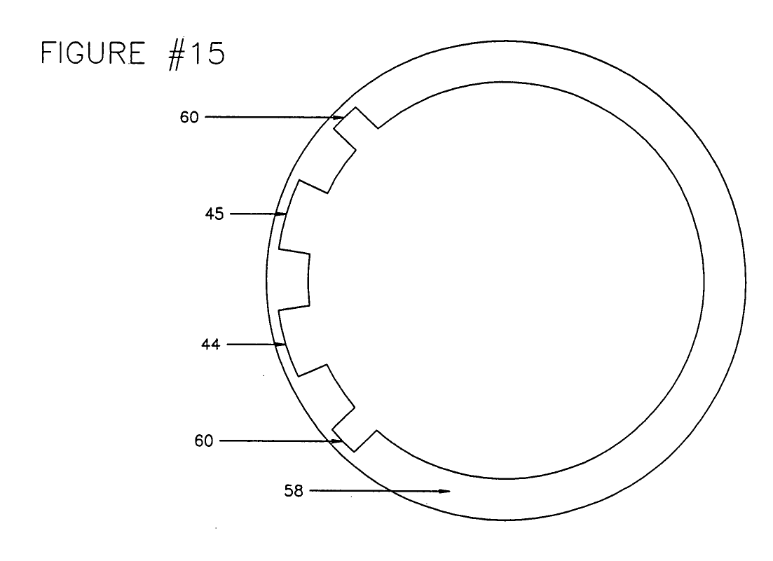

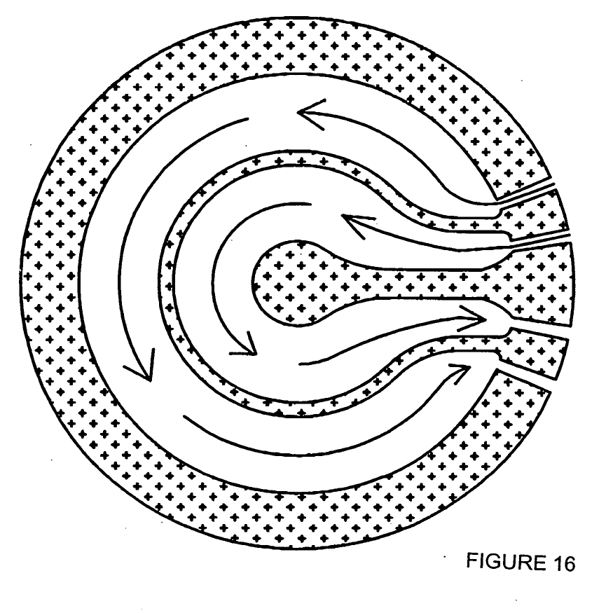

According to a third embodiment of the invention, and referring to FIGS. 10-16, the ozone generator 10 has a cylindrical shape with circular, flat disc-shaped electrode plates 14 and dielectric plates 16 mounted to annular divider frames 22 stacked together. Unlike the first two embodiments, the feed gas flow path is configured inside the stack 12 so that feed gas is fed in parallel to each electrode plate 14 through feed gas intake and exhaust manifolds 44, 45 extending the height of the stack 12 (shown in FIG. 15).

Referring to FIG. 10, the perforated electrode plate 14 has a conductive tab 49 extending radially outwards and connects to the AC coils 32 in place of the conductive wires 22 used in the generators 10 of the first two embodiments.

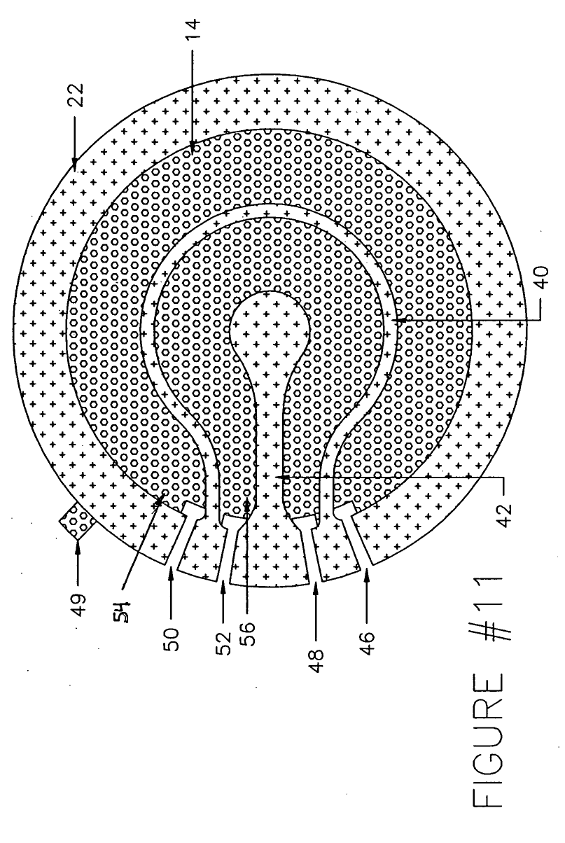

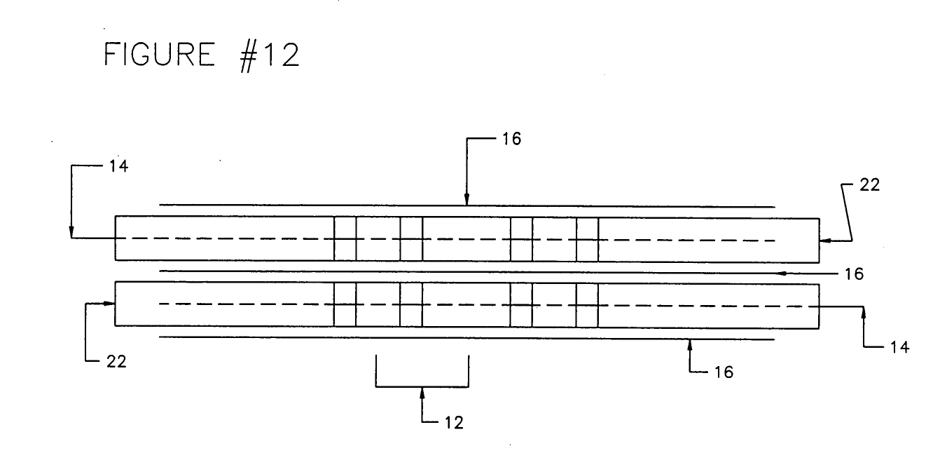

Referring to FIG. 11, each divider frame 22 in the generator 10 of this embodiment is injection-molded directly onto a corresponding electrode plate 14. This has been found to reduce stack assembly time as well as create more consistent spacing in the feed gas flow path than by inserting electrode plates 14 into pre-formed grooves of divider frames 22. Internal dividers 40, 42 are mounted on the surface of each electrode plate 14 to create inner and outer circular feed gas flow field channels across the electrode plate 14. The divider frame 22 is provided with a pair of feed gas inlets 46, 48 and a pair of feed gas outlets 50, 52 through its lateral edge. An outer feed gas flow field channel 54 is defined by the divider frame 22, outer internal divider 40, electrode plate 14 and dielectric plate 16 (shown in FIG. 12) and is open at one end to outer feed gas inlet 46 and at its other end to outer feed gas outlet 50. An inner feed gas flow field channel 56 is defined by the outer internal divider 40, inner internal divider 42, electrode plate 14 and dielectric plate 16, and is open at one end to inner feed gas inlet 48 and open at its other end to inner feed gas outlet 52. The inner and outer feed gas flow field channels 54, 56 define two distinct feed gas flow fields for each electrode plate 14.

Referring to FIG. 12, the generator stack 12 is formed by stacking each divider/electrode plate unit together inside the cylindrical housing 58, with an dielectric plate 16 sandwiched in between each unit. Referring to FIG. 15, the housing 58 is a open cylindrical body and has open-faced channels that extend the length of the inside surface of the cylinder. In particular, the channels are a feed gas inlet manifold 44, a feed gas outlet manifold 45, and a pair of conductive tab channels 60. The stack 12 is aligned inside the housing 58 so that the stack's feed gas inlets 46, 48 and feed gas outlets 50, 52 are aligned with the housing's feed gas inlet and outlet manifolds 44, 45, and the conductive tabs 49 are aligned with the tab channels 60. The size of the inlet and outlet manifolds 44, 45 may be selected to control the feed gas flow characteristics, e.g. flow rate, through the stack 12. Similarly, the size and shape of the feed gas inlets 46, 48 and outlets 50, 52 may be selected to control the feed gas flow characteristics.

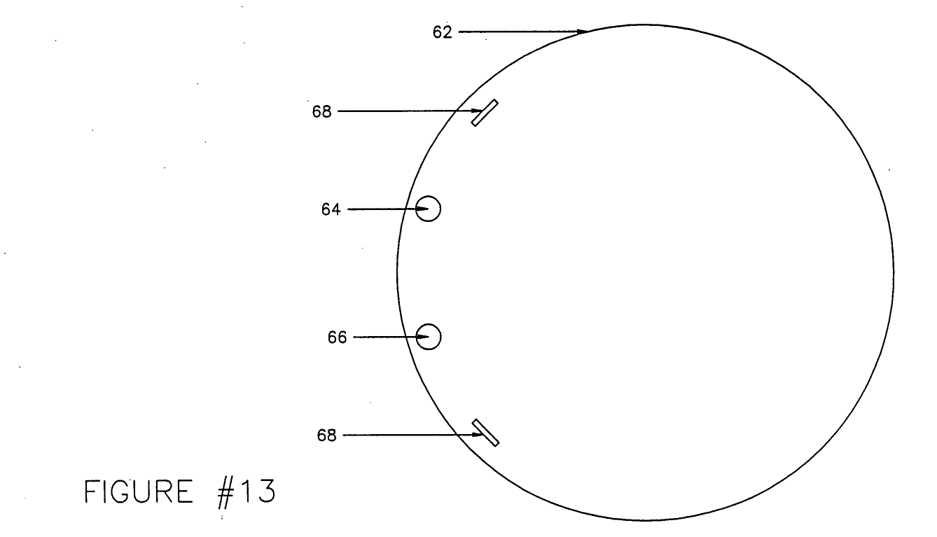

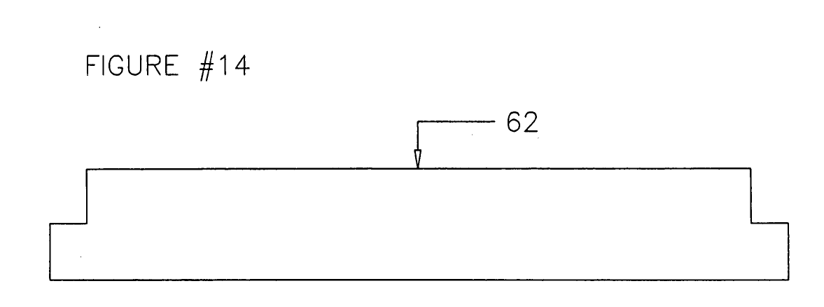

Referring to FIGS. 13 and 14, one end of the housing 58 is capped by a ported cover 62. The ported cover 62 has a feed gas inlet 64 and outlet 66 corresponding to the inlet and outlet manifolds 44, 45 and conductor apertures 68 corresponding to the conductive tab channels 60. The other end of the housing 58 is capped by a solid cover (not shown), so that flow of feed gas into and out of the stack are both via the top cover.

Like the first two embodiments, the generator 10 includes monitoring and controlling components (not shown), and the top cover feed gas inlet 64 is fluidly coupled to a feed gas source, and the top cover feed gas outlet 66 is fluidly coupled to an ozone injector of a water treatment system, so that pressurized flow of water through the injector creates a suction force that draws feed gas from the feed gas source, through the generator10, and to the ozone injector.

The stack 12 is electrically connected to the AC coils 32 via the conductive tabs 49. Corona discharge and ozone generation is carried out in a manner similar to the generator 10 of the first two embodiments, except of course that the flow path through the generator 10 of this third embodiment is different. The feed gas flow path of this third embodiment has been found to provide certain advantages over the serial, serpentine flow path of the first two embodiments. In particular, the ozone output from a generator based on the third embodiment has been found to be greater than same-sized stacks based on the first or second embodiments, especially for generators having larger stack sizes. It is theorized that the improved performance is due to improved feed gas flow characteristics caused by turbulent flow created by flow through the unequal lengths of each circular flow channel 54, 56 in each electrode 14. Also, it is theorized that the parallel manifold design reduces the tendency for the carrier feed gas to saturate with ozone, as may happen in a serial feed gas flow path where increasing the size of the stack lengthens the flow path.

Also, it has been found that the circular flow channel configuration along with the parallel manifold design enables a higher flow rate of feed gas through the generator 10, which improves the cooling of the generator 10.

While the present invention has been described herein by the preferred embodiments, it will be understood to those skilled in the art that various changes may be made and added to the invention. The changes and alternatives are considered within the spirit and scope of the present invention.

What is claimed is:

1. A corona discharge ozone generator comprising
(a) at least two flat metallic electrode plates arranged in substantially parallel spaced-apart configuration, each electrode plate electrically connectable to an electric power source, and at least one of the electrode plates being perforated;
(b) a dielectric member interposed between each pair of electrode plates; and
(c) a feed gas flow path extending through the space between each pair of electrode plates and past the interposed dielectric member,
the generator being operable to create a corona discharge that generates ozone from an oxygen-containing feed gas flowing through each flow path.

2. The generator of claim 1 wherein the electrode plates are stainless steel.

3. The generator of claim 1 wherein all the electrode plates in the generator are perforated.

4. The generator of claim 1 wherein the flow path extends over substantially all of the confronting surfaces of each pair of electrode plates.

5. The generator of claim 1 wherein the at least one perforated electrode plate comprises a plurality of holes arranged in a staggered grid pattern.

6. The generator of claim 1 wherein the at least one perforated electrode plate comprises a plurality of substantially circular holes.

7. The generator of claim 6 wherein the holes are substantially evenly distributed across the electrode plate.

8. The generator of claim 7 wherein 23%+/−5% of the electrode plate surface area is perforated by the substantially circular holes.

9. The generator of claim 1 wherein the electrode plates and dielectric plates are vertically stacked in such a manner that the adjacent flow paths are fluidly interconnected, thereby forming a continuous flow path from one end of the stack to the other.

10. The generator of claim 9 wherein the dielectric plates are horizontally positioned in the stack in such a manner that forms a continuous serpentine flow path from one end of the stack to the other.

11. The generator of claim 10 wherein the dielectric plates are horizontally positioned in the stack to direct the flow of feed gas past a single electrode plate with each horizontal pass in the serpentine flow path.

12. The generator of claim 11 wherein the dielectric plates are horizontally positioned to direct the flow of feed gas past a pair of electrode plates with each horizontal pass in the serpentine flow path.

13. The generator of claim 1, wherein each dielectric plate is made of fired alumina.
